(19) United States
(12) Patent Application Publication
(10) Pub. No.: US 2026/0249501 A1
(43) Pub. Date: Aug. 27, 2026

(54) CUTTING DEVICE FOR CUTTING A BAND-LIKE MATERIAL, IN PARTICULAR A TACKY CORD BAND, AND METHOD FOR DETERMINING AND OUTPUTTING WEAR INFORMATION CONCERNING A FIRST AND/OR SECOND BLADE ELEMENT OF A CUTTING DEVICE

(71) Applicant: Fischer TireTech Germany GmbH, Burgkunstadt (DE)

(72) Inventor: Frank SCHMIDT, Thurnau (DE)

(21) Appl. No.: 19/536,685

(22) Filed: Feb. 11, 2026

(30) Foreign Application Priority Data
Feb. 25, 2025 (DE) 10 2025 107 141.1

(51) Int. Cl. B26D 5/00; B26D 1/18; B26D 7/26

(52) U.S. Cl. CPC B26D 5/007; B26D 1/185; B26D 5/00; B26D 7/2635

(57) ABSTRACT

A cutting device for cutting a band-like material, in particular a tacky cord band, including two blade elements interacting with one another for the cutting, each blade element being arranged on a blade support, which in turn is arranged directly or indirectly on a device framework, wherein at least one oscillation sensor is provided, by way of which oscillation information which is a measure of an oscillation of the blade elements produced by the interaction of the blade elements during a cut can be acquired, and in that a processing device, designed for determining on the basis of the oscillation information wear information indicating the state of one or both blade elements, and also a display device, for outputting wear information determined, are provided.

### CROSS-REFERENCE TO RELATED APPLICATIONS

The present application claims priority of DE 10 2025 107 141.1, filed Feb. 25, 2025, the priority of this application is hereby claimed, and this application is incorporated herein by reference.

### BACKGROUND OF THE INVENTION

The invention relates to a cutting device for cutting a band-like material, in particular a tacky cord band, comprising two blade elements interacting with one another for the cutting, each blade element being arranged on a blade support, which in turn is arranged directly or indirectly on a device framework.

Cutting devices of the type described are used for example in tire production. They serve the purpose of cutting band-like material, in particular a tacky cord band, either steel cord or textile cord. The term “cutting device” is understood in this case to mean various types of machine. They are broadly divided into shears and slitters. Used here for example as shears are guillotine shears, that is to say squaring shears with a bar-like, vertically movable upper blade and a bar-like, positionally fixed lower blade, circular-blade or rotary shears with a rotating, horizontally movable circular blade and a positionally fixed blade bar or shears with a saw blade rotating at high speed. These shears serve the purpose of cutting off individual sections of band from a continuous band. Various such shears are described for example in DE 20 2013 103 082 U. A slitter serves the purpose of dividing a continuous band lengthwise, so that two or more part-bands are created. Usually, two circular blades interacting with one another and separating the material are used here.

Irrespective of the type of cutting device, the respective blade systems are subject to a certain amount of wear. Depending on the stress and wear they undergo, corresponding maintenance or adjustment work must therefore be performed. It is in this respect difficult to determine the timing for carrying out maintenance or changing a blade or making an adjustment during operation. In practice, the state of the respective blade system is checked by the maintenance personnel at defined maintenance intervals and, if required, the blade system is correspondingly adjusted, that is to say corrected, or if there is increased wear the blade system is changed. However, until it is detected that an adjustment or a change of blade is required, operation continues however, possibly involving the production of a corresponding amount of reject material. If it is detected that intervention is required, this results in the cutting device, and consequently the complete installation, being shut down, and therefore inevitably a loss of production. Since, apart from the number of cutting operations, the stress on the blade system of course also includes for example the type of material, the width of the material and the thickness of the material, there are consequently various parameters that induce wear, which makes it all the more difficult to detect in time wear that requires action.

### SUMMARY OF THE INVENTION

The invention therefore addresses the problem of providing a cutting device that is improved in comparison.

To solve the problem, in the case of a cutting device of the type mentioned at the beginning at least one oscillation sensor is provided, by way of which oscillation information which is a measure of an oscillation of the blade elements produced by the interaction of the blade elements during a cut can be acquired, and a processing device, designed for determining on the basis of the oscillation information wear information indicating the state of one or both blade elements, and also a display device, for outputting wear information determined, are provided.

The invention is based on the realization that during each cut the blade system produces oscillations which lead to vibrations on the device. It has thus been found that these oscillations or the oscillation spectrum change(s) over time, and therefore with increasing wear of the blade elements; generally, stronger oscillations or vibrations occur, resulting from wear-dependent incorrect setting, which would require an adjustment, or from corresponding wear of the blade elements, which means reduced quality of the cut. Wear-dependently, the oscillation amplitudes increase, i.e. there are greater oscillatory accelerations on the blade elements or the blade supports or device elements coupled thereto into which the oscillations are introduced. According to the invention, an oscillation produced during a cut, or the accompanying vibrations, which are produced by the interaction of the blade elements and the band material, is/are thus sensed by means of at least one oscillation sensor. The oscillation sensor therefore provides oscillation information in the form of the sensor signals, which replicate the oscillations or vibrations and are based on the interaction of the blade elements cutting the band material. The sensor signals are passed to a processing device, which is designed for processing the sensor signals and, based on them, determining wear information. This wear information ultimately provides information about the state of the blade system or the blade elements, so that the wear information is an indicator of whether the blade system is cutting the band material according to requirements, or whether the cutting quality has deteriorated because of wear, resulting from incipient or advanced wear of the blade elements. The wear information therefore ultimately provides information about whether or not action on the part of the maintenance personnel is required.

According to the invention, the wear information is output, accessibly for the maintenance personnel, on a display device, for example a monitor or an illuminated display or the like, so that the personnel can easily acquire the wear information and draw corresponding conclusions. The wear information may in this case be extremely simple in its informational content, for example in the manner of a color display, which may for example also be structured in the manner of a traffic light system. If the wear information determined indicates that the oscillations occurring in the monitored cut or multiple oscillations or spectra recorded within a monitoring cycle lie in a tolerance range assigned to a blade system exhibiting no wear or only negligible wear, then for example a green indicator light may be shown. If the oscillations or the oscillation spectrum lie(s) in a tolerance range assigned to a blade system with wear occurring, but acceptable, then for example a yellow indicator light may be shown as a warning signal, whereas, when there are sensed oscillations or oscillation spectra which lie in an interval assigned to increased or high wear of the blade system, then a red indicator light may be shown as an alarm signal, which requires quickest possible action. This traffic light system therefore allows the timely detection of a certain amount of wear, so that corresponding precautions can be taken, and either preventive action can be taken before excessive wear is sensed, or immediate action can be taken if such excessive wear is sensed. Apart from such a colored light system, any other type of display, for example in text form or else a symbol field etc., is of course also conceivable to communicate the respective wear information correspondingly.

The system therefore allows an almost continuous monitoring of the cutting behavior, to be precise process-independently, i.e. independently of which type of device is concerned, that is to say whether shears, and if so what type of shears, or a slitter etc. is/are being considered, and independently of the cut material, that is to say whether it is steel cord or textile cord, which thickness of material is being cut etc., since only the respective oscillation or vibration behavior is taken into consideration, the cause of which is the cutting quality alone, which in turn causally depends on the quality of the blade system. Consequently, the use of the at least one oscillation sensor allows the progression of the cut to be continuously sensed and processed analytically by the processing device and a finding concerning the wear of the blade system to be output in the form of the wear information. This makes it possible to sense and communicate any wear in real time, so that an appropriate response can be provided in time. Manual intervention on the part of the maintenance personnel to check the blade system, involving necessary shutting down of the cutting device, is therefore not necessary. Rather, maintenance or else a possible change of blade can be planned at an early time when wear is detected, so that downtimes of the cutting device due to blade wear during production can be avoided and a high level of product quality can be maintained, while at the same time avoiding reject products.

As described, the processing device serves for determining the wear information on the basis of the oscillation information determined by way of the oscillation sensor, that is to say the sensor signal. In the course of this determination, as a development of the invention, the processing device may be designed the wear information on the basis of a comparison of the oscillation information or comparative information determined on the basis thereof with at least one item of reference information. In the processing device, specific reference information is stored for the type of cutting device, possibly specified with respect to the cut material, that is to say for example reference oscillation modes or reference oscillation spectra assigned to various states of wear. The processing device is thus designed for the purpose of comparing either directly the sensor signals provided by the oscillation sensor or comparative information determined on the basis thereof, that is to say for example comparative values such as oscillation amplitude values or oscillatory acceleration values, with the reference information, which of course is correspondingly defined, that is to say for example is a comparative amplitude value or a comparative acceleration value. By way of this comparison, it can accordingly be easily detected which degree of wear is assigned to a sensed actual oscillation or a sensed actual oscillation value, so that corresponding wear information can be easily determined.

It is in this case preferred that, in addition to the actual sensor signal, one or more material parameters, in particular the thickness and width and type of the material (for example steel or textile cord) is/are also sensed, these material parameters also being assigned to the reference information, so that the reference information assigned to the monitored operation is used for purposes of comparison. The measured value acquisition in this case takes place continuously, i.e. the data are recorded in real time during the process and are processed by the processing device, which for this purpose has corresponding processing algorithms. In the case of good progression of the cut, that is to say in the case of a wear-free blade system or a blade system exhibiting only very little wear, the oscillation information or the signal waveform provided by the oscillation sensor shows a clear, relatively sharp progression with a relatively sharp peak in a very narrow frequency range, which is distorted only little at lower and higher frequencies, while the oscillation information or the signal waveform in the case of a more severely or severely worn blade system is more severely or severely distorted or smeared, and may have multiple peaks at various frequencies and the like, which is an indication of corresponding blade wear. The frequency of the oscillations or vibrations is in this case in the kilohertz range. The reference information is stored in the processing device and was recorded in advance. If the processing algorithm that performs the processing of the sensor signals and the determination of the wear information is a self-learning algorithm, possibly in the manner of artificial intelligence, the algorithm may be trained on the basis of the reference information recorded in advance in relation to specific forms of wear and operating parameters etc., that is to say for example reference signal waveforms. A self-learning system also further develops itself in the course of operation on the basis of the continually recorded sensor information, so that the processing becomes ever more specific and accurate over time.

According to a particularly advantageous development of the invention, it is provided that the processing device is designed for determining a comparative value, in particular a mean value, which serves as comparative information, on the basis of multiple items of oscillation information recorded one after the other in time. As described, the cutting behavior is monitored, and corresponding oscillation information recorded, almost continuously, while it is not necessary for each cut to be accompanied by a corresponding signal recording, but instead this need only take place at defined intervals, for example after every 10th, 50th or 100th cut. It is also possible for multiple items of oscillation information, recorded quickly one after the other, of multiple cuts performed quickly one after the other to be acquired at each acquisition time, and for example from these a defined measured value to be considered in each case and a mean value to be formed for this cycle and used as a basis for the further processing. Within each item of recorded oscillation information, a defined measured value is considered and used as a basis for the further processing. This measured value is for example the maximum oscillatory acceleration occurring or the maximum amplitude within the oscillation signal. Thus, over time a corresponding slew of oscillation information is obtained, or measured values determined therefrom, which can be represented in a diagram as a curve. The processing device is thus capable of processing these multiple items of oscillation information recorded one after the other in time for determining a comparative value such as a mean value or a mean-value curve. This comparative value represents the comparative information that is taken into consideration in the course of the comparison with the reference information.

In this case, this reference information may describe a state or be assigned to a state which describes sufficiently severe wear, and which requires prompt action. If it is found that the comparative information, that is to say the current comparative value resulting from the last-recorded vibration behavior, corresponds to the reference information or is greater than it in terms of value, a corresponding indication may be output, requiring intervention on the part of personnel. If for example the maximum oscillatory acceleration in the oscillation spectrum is determined as signal information to be processed and the comparative value is determined on the basis of this, a corresponding reference value, assigned to a defined state of wear and likewise describing an oscillatory acceleration, is likewise used as reference information in the course of the comparison.

It is in this case also conceivable that there is at least a first and a second item of reference information, while a first item of wear information can be output in dependence on a comparison of the comparative value with the first item of reference information and a second item of wear information can be output in dependence on a comparison of the comparative value with the second item of reference information. The information system is accordingly formed with progressive stages. If it is found by the comparison that the comparative information corresponds to the first item of reference information or is greater than it, then, for example in the manner of the traffic light system, a yellow indicator light may be shown as a warning signal for a forthcoming required intervention. If it is found in the course of the comparison that the comparative information corresponds to the second item of reference information or is greater than it, then a red indicator light may be shown as an alarm signal.

Even though it is possible with a single oscillation sensor for corresponding oscillation information to be recorded, it is of course conceivable that multiple oscillation sensors, arranged at various positions, are provided, the processing device being designed for determining the wear information on the basis of the oscillation information of the multiple oscillation sensors. The separate sensor signals are processed separately and compared with their own reference information, so that there is a redundancy, and accordingly, in the event of failure of one oscillation sensor, a corresponding wear measurement continues to be possible, and of course a comparison of the resultant evaluation results by the processing device with one another is also possible, and consequently a kind of verification. Of course, a correspondingly broader database is also obtained and can be taken into consideration in the course of a long-term evaluation.

As described, the oscillations are produced by the blade system, that is to say by the interacting blades, for which reason it is expedient if the oscillation sensor or at least one of the multiple oscillation sensors is arranged on a blade support, so that the oscillation behavior is ultimately sensed directly at the place it is produced. It is however also conceivable to arrange the oscillation sensor or at least one of the multiple oscillation sensors on the device framework. As described, the blade supports are ultimately always mechanically coupled to the device framework, so that any oscillations produced by the blade elements are inevitably also coupled into the device framework, where they can be sensed by means of the oscillation sensor.

As described, the cutting device may take the form of various types. One type of device is squaring shears, therefore also known as guillotine shears. In the case of these shears, an upper blade, which is arranged on a first blade support, is provided as a first blade element and a lower blade, which is arranged on a framework support which is provided on the device framework, is positionally fixed and serves as a second blade support, is provided as a second blade element. In the case of this type, the oscillation sensor or one of the multiple oscillation sensors is arranged on the first blade support or a blade-support guide provided on the device framework, that is to say in the region of the upper blade, or on the framework support, that is to say in the region of the lower blade. The framework support may also be a tabletop over which the band material fed to the blade system is conveyed.

It is in this case conceivable in a development of this variant that at least one first oscillation sensor is provided on the first blade support or the blade-support guide and at least one second oscillation sensor is provided on the framework support. Consequently, two oscillation sensors, which respectively provide separate measurement signals that can be correspondingly evaluated, are arranged on both oscillation-producing elements or in the direct vicinity of the same.

Of course it is possible also to provide multiple first oscillation sensors on the first blade support or the blade-support guide and/or multiple second oscillation sensors on the framework support, i.e. that more than two oscillation sensors are arranged distributed at various positions.

A further type of device is rotary shears. These may have a rotary blade, which is arranged on a horizontally movable blade support, as a first blade element and a positionally fixed blade bar, which is arranged on a framework support which is provided on the device framework, is positionally fixed and serves as a second blade support, and along which blade bar the rotary blade is movable, as a second blade element, an oscillation sensor being arranged on the first blade support or a guide of the first blade support that is provided on the device framework or being arranged on the framework support or on the device framework. This cutting device is distinguished by the combination of a horizontally movable rotary blade, which moves along a horizontally running, positionally fixedly arranged blade bar and thereby cuts the band material. Here, too, if only one oscillation sensor is provided, it may be arranged at various positions, while here, too, of course multiple oscillation sensors may also be provided at various positions. Here, too, the framework support on which the blade bar is arranged may again be a tabletop supporting the band material before it is cut.

A configuration of the cutting device as a slitter may have a first rotary blade as a first blade element and a second rotary blade as a second blade element, the first rotary blade being arranged on a first blade support that is movable on the device framework and the second rotary blade being arranged on a second blade support that is arranged positionally fixed on the device framework, an oscillation sensor being arranged on the first blade support or a guide of the first blade support provided on the device framework or being arranged on the second blade support or on the device framework. The band material that is to be cut lengthwise here runs between the two rotary blades and is cut into corresponding part-bands. In this case, one of the rotary blades is arranged on a horizontally movable first blade support, for example an adjustment plate, by way of which an adjustment of the first rotary blade relative to the second rotary blade is possible. The second rotary blade is fastened on a second blade support arranged positionally fixed on the device framework. Here, too, the one oscillation sensor or the multiple oscillation sensors may in this case be arranged at various positions.

The descriptions and enumeration of the various types of cutting device that can be equipped with the wear-detection system according to the invention is/are not exhaustive; rather, the wear-detection system may also be integrated on other cutting devices not explicitly mentioned here.

Apart from the cutting device itself, the invention also relates to a method for determining and outputting wear information concerning a first and/or second blade element of a cutting device, the cutting device having a device framework and also two blade elements interacting with one another for the cutting, each blade element being arranged on a blade support, which in turn are arranged directly or indirectly on the device framework, while oscillation information which is a measure of an oscillation of the blade elements produced by the interaction of the blade elements during a cut is acquired by means of at least one oscillation sensor, and while wear information indicating the state of one or both blade elements is determined by means of a processing device on the basis of the oscillation information and is output by way of a display device.

In a development of the method, the processing device may in this case be designed for determining the wear information on the basis of a comparison of the oscillation information or comparative information determined on the basis thereof with at least one item of reference information.

Furthermore, a comparative value, in particular a mean value, which serves as comparative information, may be determined by means of the processing device on the basis of multiple items of oscillation information recorded one after the other in time.

Furthermore, it may be provided according to the method that there is at least a first and a second item of reference information, while a first item of wear information is output in dependence on a comparison of the comparative value with the first item of reference information and a second item of wear information is output a comparison of the comparative value with the second item of reference information. This allows a staged output of information, that is to say for example information indicating that the system is operating correctly, followed by first warning information when wear is sensed, and second alarm information when there is excessive wear. This may be realized in the form of a color-coded traffic light system.

Furthermore, it may be provided according to the method that multiple oscillation sensors, arranged at various positions, are provided, the processing device determining the wear information on the basis of the oscillation information of the multiple oscillation sensors. This allows a redundancy and also a corresponding cross-comparison or a verification of the wear information determined.

Finally, it may be provided that squaring shears comprising a vertically movable upper blade as a first blade element and a positionally fixed lower blade as a second blade element, or rotary shears comprising a horizontally movable rotary blade and a positionally fixed blade bar, along which the rotary blade moves, or a slitter comprising a movable first rotary blade and a positionally fixed second rotary blade is/are used as the cutting device.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a basic representation of a cutting device according to the invention in the form of guillotine shears,

FIG. 2 shows the cutting device from FIG. 1 in a side view,

FIG. 3 shows an enlarged basic representation of the blade system with assigned oscillation sensors,

FIG. 4 shows a basic representation of the progression over time of various items of oscillation information in the form of a curve plot with a mean-value curve,

FIG. 5 shows a basic representation of a cutting device according to the invention in the form of a slitter,

FIG. 6 shows a basic representation of a cutting device according to the invention in the form of rotary shears,

FIG. 7 shows a basic representation of a cutting device according to the invention in the form of guillotine shears corresponding to FIG. 1, showing various positioning possibilities for oscillation sensors, and

FIG. 8 shows the cutting device from FIG. 7 in a side view.

### DETAILED DESCRIPTION OF THE INVENTION

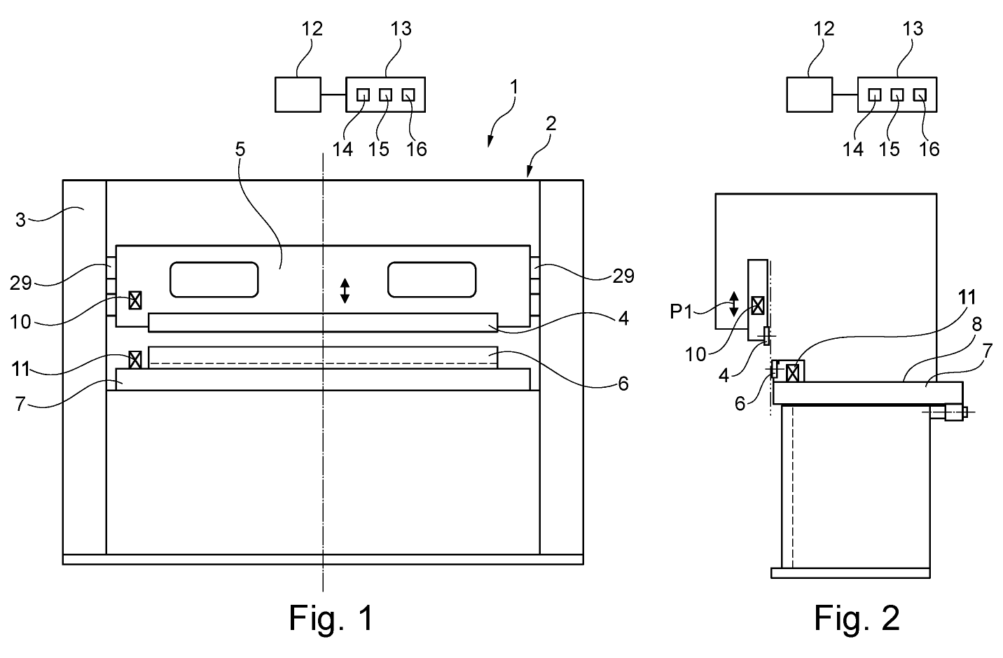

FIG. 1 shows a basic representation of a cutting device 1 according to the invention in the form of guillotine shears 2 in a view from the front side, whereas FIG. 2 shows the cutting device 1 from FIG. 1 in a side view. The cutting device 1 comprises a device framework 3, comprising an upper blade 4, which is arranged on a first blade support 5, which is held in lateral blade-support guides and is vertically movable by way of a servo drive, as represented by the double-headed arrow P1. It can therefore be moved from a raised position into a lowered cutting position, in which the cutting of the band material brought up to it takes place.

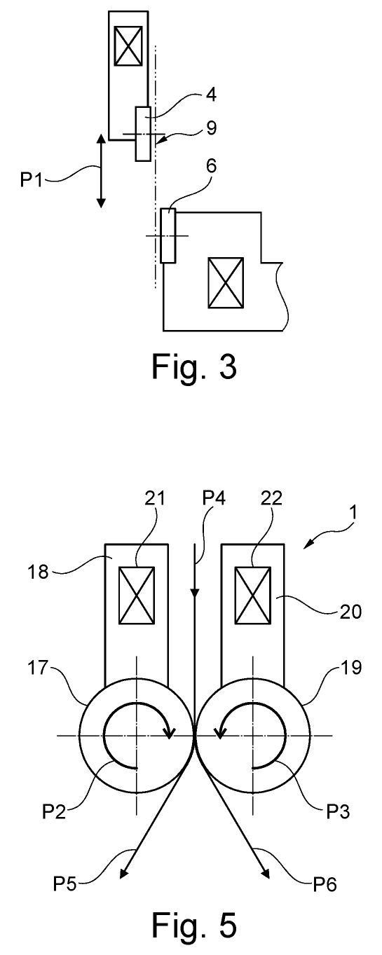

This cutting takes place by the upper blade 4 interacting with a lower blade 6, which is arranged positionally fixed on a second blade support 7, which is for example a tabletop 8, while this second blade support 7 is arranged positionally fixed on the device framework 3. I.e. the lower blade 6 is positionally fixed, while the upper blade 4 is vertically movable relative to it. The upper blade 4 and the lower blade 6 are spaced slightly apart by way of a cutting gap 9, as indicated by FIG. 3, which shows an enlarged partial view of this blade system.

During operation, the band material to be cut is pulled through between the upper blade 4 and the lower blade 6 by way of a suitable transporting device comprising a pulling device with a suitable gripper mechanism. In a cutting position, the band material is fixed, after which the upper blade 4 is moved vertically downward and, by interacting with the lower blade 6, cuts the band material. The cut section of band is then transported away and, after moving the upper blade 4 up, a further section of the band material is again pulled through. The cutting takes place with a relatively high frequency, i.e. multiple cuts per minute are carried out, which represents a correspondingly stress, in particular on the upper blade 4 and the lower blade 6, and also on their correct positioning relative to one another by way of the cutting gap 9. Over time, wear may occur, either on the upper blade 4 or the lower blade 6 itself, i.e. their cutting edges become worn, or with respect to the originally defined setting of the width of the cutting gap 9, which may become smaller or larger during the course of operation.

With every cut of the band material there are minimal oscillations, triggered by the interaction of the upper blade 4 with the lower blade 6 together with the band material. These oscillations are therefore produced by the two blade elements and are coupled into the two blade supports 5, 7 or into the device framework 3 by way of these elements. The oscillations are brief, high-frequency vibrations in the kilohertz range. If the upper blade 4 and the lower blade 6 are not worn and the cutting gap 9 is optimally set, very weak oscillations occur, with a small oscillation amplitude to the sides of a central peak, i.e. there is only a slight oscillatory acceleration of the components involved. With increasing wear, however, there is a change in the oscillation behavior or the oscillation waveform when a cut is made, that is to say the oscillation spectrum. It will usually increase, i.e. the oscillations become stronger, the oscillation spectrum exhibits greater amplitudes and also a corresponding distortion or smearing with multiple peaks over a greater frequency range. I.e. the oscillation behavior, and consequently acquirable oscillation information, changes with increasing wear, so that in principle the degree of wear can be concluded on the basis of the oscillation information that can be acquired.

For this purpose, in the example shown two oscillation sensors 10, 11 are provided, the oscillation sensor 10 being arranged on the first blade support 5 if the second oscillation sensor 11 is arranged on the second blade support 7. Each oscillation sensor 10, 11 provides a corresponding sensor signal, which is permanently provided and exhibits a signal increase right at the beginning of the cut, that is to say when the two blade elements and the band material interact. The sensor signals recorded for the respective cut, that is to say the oscillation information, is/are passed to a processing device 12, which is designed to process the oscillation information or sensor signals with the aid of a stored processing algorithm and to determine on the basis of the sensed sensor signals wear information which reflects the degree of wear.

For this purpose, the processing device is designed for a comparison of the oscillation information, that is to say for example the provided sensor signal directly, with an item of reference information. According to the type of oscillation information concerned, this reference information stored in the processing device 12 can be designed correspondingly. Each item of reference information that is stored, and has previously been recorded in relation to the specific cutting device or its type, is assigned to a specific state of wear. The processing device thus compares for example the oscillation information in the form of the signal waveform with reference information which is likewise a signal waveform. The reference information is in this case stored in the processing device 12 with a multiplicity of further items of reference information assigned to various states of wear and operating or material parameters, i.e. there is a corresponding slew of information for the comparison. Depending on what is the best match for the oscillation information to be compared, the degree of wear can be determined from the correspondingly matching reference information, that is to say wear information can be determined. This wear information is shown on a display device 13, which is for example a monitor with a color display capability. Depending on whether the wear information indicates that there is no wear, or that there is tolerable but already commencing wear, or more severe or severe wear that requires action, one of the three indicator lights 14, 15, 16 may be shown. If there is no wear, for example the green indicator light 14 lights up; if there is commencing, but tolerable wear, the yellow indicator light 15 lights up as a warning signal; if there is severe wear, requiring quick action, the red indicator light 16 lights up as an alarm signal. There is therefore a kind of traffic light system.

Since two oscillation sensors 10, 11 are provided, the processing device can process the two separately and carry out a comparison for each, so that two results to be compared to one another are obtained, allowing one comparison to be used for guidance and the other comparison to be used for checking plausibility.

The oscillation information may be recorded for each individual cut, and a corresponding comparison, and consequently wear information, determined for each cut. It is also conceivable however to do this only intermittently, for example for every 10th, 20th, 50th or 100th cut. It is also conceivable to record the signal at staggered time intervals, for example every minute, every 5 minutes etc. In this case it is conceivable to record and evaluate in each signal recording cycle the oscillation signals for multiple cuts, for example five cuts following immediately one after the other, and on the basis thereof to determine for example a common measured value, which is for example determined by averaging and is used as oscillation information as a basis for the comparison. I.e. there are various evaluation possibilities.

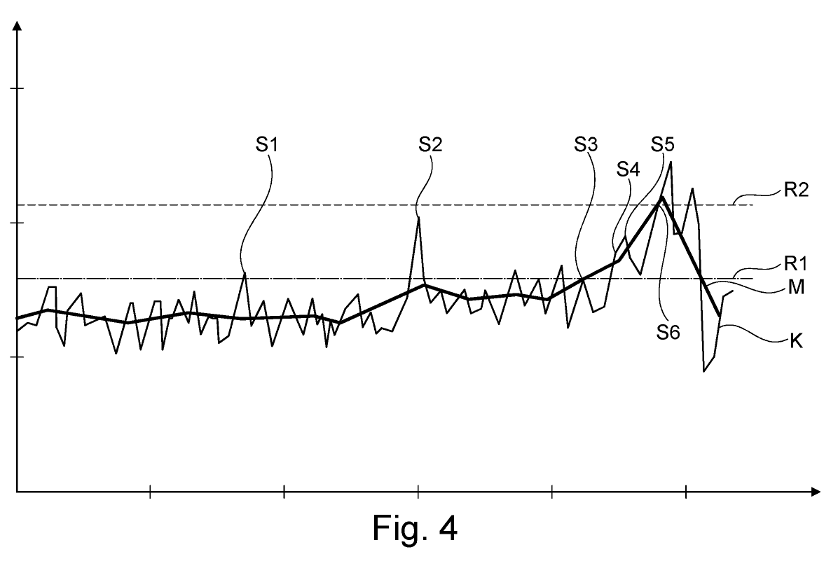

FIG. 4 shows an example of a shape of a curve plotted over a multiplicity of individual recorded items of oscillation information, and also an assigned mean-value curve. Indicated along the x axis is the measurement number, along the y axis for example the respective maximum amplitude of the measured oscillation or the maximum oscillatory acceleration within the measured oscillation. It should be assumed that, with each measurement, either the maximum amplitude in each case of the oscillation, that is to say the maximum peak, or a maximum oscillatory acceleration is determined from the respective sensor signal as oscillation information, which is subsequently compared with the reference information. In FIG. 4, multiple such items of oscillation information S1-S6 are marked, chosen merely by way of example. Overall, this gives a curve K, which is plotted along the individual items of oscillation information.

Also shown is a mean-value curve M, which is determined by averaging along the curve K.

Shown furthermore is a first item of reference information R1 in the form of the dash-dotted line, which runs horizontally, and a second item of reference information R2 in the form of a dashed line, which likewise runs horizontally. The reference information R1 indicates a first information stage; the reference information R2 a second information stage. Each recorded item of oscillation information, that is to say each amplitude value or acceleration value, is compared with the reference information R1 and R2. Depending on the result of the comparison, one of the three indicator lights is shown. The two items of reference information R1 and R2 consequently represent separate information limits. The reference information R1 is a warning limit. If this stage is reached, warning information is given in the form of the yellow indicator light 15. The reference information R2 is an alarm limit, i.e., when this state is reached, alarm information is given in the form of the red indicator light 16. Below the reference information R1, the green indicator light 14 is shown, indicating that operation is proceeding properly.

As described, the curve K is determined on the basis of the individual items of sensor information; it therefore follows their progression. It shows the individual items of sensor information, which vary relatively, i.e. the respective determined sensor information may be or is different from measurement to measurement, so that the relatively spiky shape of the curve K is obtained. While most of the items of sensor information at the beginning of the curve are less than the first item of reference information R1, the items of sensor information S1 and S2 for example lie above the reference information R1, which would result in a corresponding warning indication being output if this alone were considered. To avoid this, since this is only a snapshot, the mean-value curve M is determined, running well below the reference information R1.

FIG. 4 also shows however that, over time, as the measurement number increases, the mean-value curve M rises. When the sensor information S3 is acquired, a mean value which is equal to or greater than the reference information R1 is obtained, which has the effect that the green indicator light 14 shown up until then changes to the yellow indicator light 15. This indicates that in the meantime there is indeed significant wear, which possibly requires preplanning of an intervention. As the figure shows, the oscillation information is then on an upward trend, as shown by way of example by items of oscillation information S4 and S5, which has the effect that the mean-value curve M also rises. With the inclusion of the sensor information S6, the mean value is equal to or greater than the second reference information R2, which has the effect that the third, red indicator light 16 is shown, indicating that quickest possible action is required, since there is severe wear, which is to be countered either by setting the cutting gap 9 or by changing a blade. An alarm signal is therefore issued. In the example, this is rapidly followed by a response, shown by the fall in the curve K and also the mean-value curve M. I.e. the point in time at which wear that is no longer tolerable occurs can be sensed with great accuracy, and accordingly immediate action can be initiated, to be precise at the beginning of this state. The fact that the yellow warning signal was already shown in advance allowed preparations for this moment to be made already and corresponding measures to be put in place.

As described above, the cutting device 1 is guillotine shears, also known as squaring shears. FIG. 5 shows an example of a cutting device 1 according to the invention which is configured as a slitter, which allows a continuous band material to be separated in the lengthwise direction into two part-strips. A first blade element is shown in the form of a first circular blade 17, which is movable on a first blade support 18, which is horizontally movable on the device framework, which is not shown any more specifically here, while the first blade support is for example an adjustment plate. Also provided is a second blade element in the form of a second circular blade 19, which is arranged on a positionally fixed second blade support 20. The two rotate oppositely, which is represented by the arrows P2 and P3. As represented by the arrow P4, a band material runs between the two circular blades 17, 19 from above and is cut into two part-bands, as represented by the arrows P5, P6.

This also results in corresponding oscillations and vibrations, which in turn are sensed by way of two oscillation sensors 21, 22, which here are arranged on the two blade supports 18, 20, and are passed to the processing device, which is not shown any more specifically here. The manner of processing is as described above in relation to the first example.

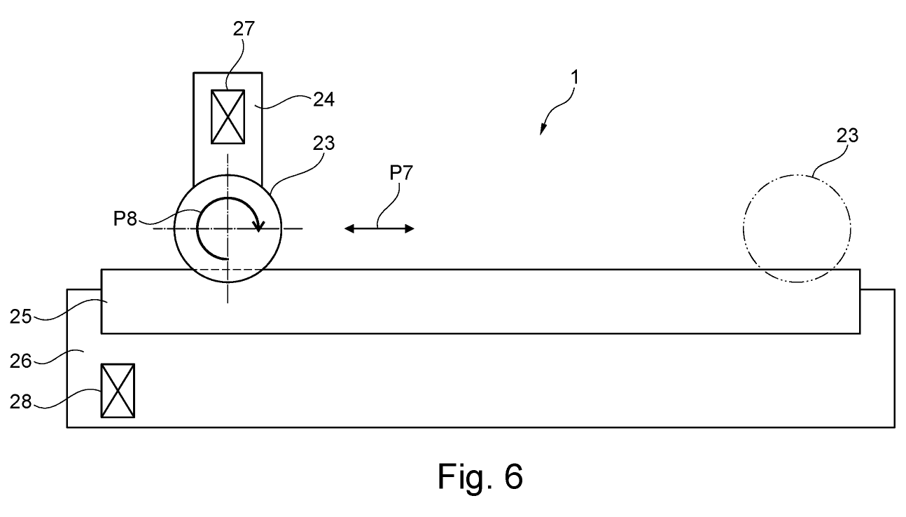

FIG. 6 shows a design of a cutting device 1 according to the invention in the form of rotary shears. A first blade element is provided in the form of a circular blade 23, which is arranged on a first blade support 24. As represented by the double-headed arrow P7, the blade support 24 is horizontally movable; here the circular blade 23 rotates clockwise, as represented by the arrow P8.

A second blade element is provided in the form of a positionally fixed blade bar 25, which is arranged positionally fixed on a framework support 26, which serves as a second blade support and is in turn for example a tabletop. Here, too, the band material is pulled through when the circular blade 23 is in the starting position shown here on the left. When the cutting position is reached, the band material is fixed; the circular blade 23 is moved by way of the blade support 24 to the right into the position shown by dashed lines, during which movement the band material is cut by the circular blade 23 interacting with the blade bar 25. Subsequently, the band material is again pulled through, the circular blade 23 being moved back again from the position shown by dashed lines, thereby cutting the band material. Alternatively, before the next cut, the circular blade 23 may also be moved again into the starting position shown in FIG. 6.

Here, too, two oscillation sensors 27, 28 are again provided. A first oscillation sensor 27 is fastened on the first blade support 24, a second oscillation sensor 28 is arranged on the framework support 26. Here, too, they communicate with a processing device not shown any more specifically, which in turn performs the processing of the sensor signals for determining the sensor information and also for carrying out the comparison for determining wear.

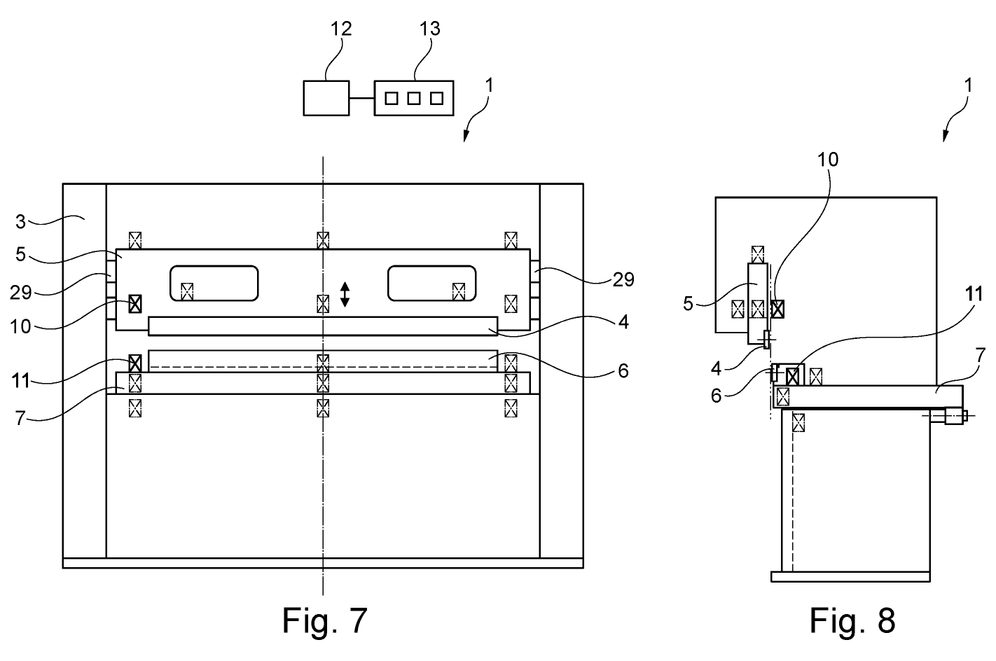

FIGS. 7 and 8 show a design of a cutting device 1 according to the invention which corresponds to the guillotine shears from FIGS. 1-3. Shown in turn are the device framework 3, the upper blade 4 with its first blade support 5 and the lower blade 6 with the framework support 7. Shown furthermore are blade-support guides 29 on both sides, in which the first blade support 5 is guided vertically movable on the device framework 3. Shown again are the two oscillation sensors 10, 11.

Additionally indicated, by way of the sensor symbols shown in each case by dashed lines, are a series of various positions at which either the two oscillation sensors 10, 11 may alternatively be positioned or at which additional oscillation sensors which altogether provide separate sensor signals may be arranged. Of course, all of the oscillation sensors are connected to the processing device 12, which performs the corresponding signal evaluation and to which the display device 13 is assigned.

It is in principle conceivable also to deduce from the wear information what form a corresponding response may take, for example if the first warning stage is reached, that is to say certain wear has been sensed, and if this state has existed over a lengthy period of time. For example, it would be conceivable to adjust the cutting gap 9 again if its width, determinable during operation, no longer lies within the tolerance. This adjustment may take place automatically, i.e. automatic correction of the cutting gap 9 may take place in dependence on the wear result. The success of this measure can be checked directly on the basis of the next measurements with respect to the cutting quality.

While specific embodiments of the invention have been shown and described in detail to illustrate the inventive principles, it will be understood that the invention may be embodied otherwise without departing from such principles.

We claim:

1. A cutting device for cutting a band-like material, in particular a tacky cord
band, comprising two blade elements interacting with one another for the
cutting, each blade element being arranged on a blade support, which in turn
is arranged directly or indirectly on a device framework, wherein at least one
oscillation sensor is provided, by way of which oscillation information which is
a measure of an oscillation of the blade elements produced by the interaction
of the blade elements during a cut can be acquired, and in that a processing
device, designed for determining on the basis of the oscillation information
wear information indicating the state of one or both blade elements, and also a
display device, for outputting wear information determined, are provided.

2. A cutting device according to claim 1, wherein the processing device is
designed for determining the wear information on the basis of a comparison of
the oscillation information or comparative information determined on the basis
thereof with at least one item of reference information.

3. A cutting device according to claim 2, wherein the processing device is
designed for determining a comparative value, in particular a mean value, which
serves as comparative information, on the basis of multiple items of oscillation
information recorded one after the other in time.

4. A cutting device according to claim 2, wherein there is at least a first and a
second item of reference information, while a first item of wear information can be
output in dependence on a comparison of the comparative value with the
first item of reference information and a second item of wear information can be
output a comparison of the comparative value with the second item of reference
information.

5. A cutting device according to claim 1, wherein multiple oscillation sensors,
arranged at various positions, are provided, the processing device being
designed for determining the wear information on the basis of the oscillation
information of the multiple oscillation sensors.

6. A cutting device according to claim 1, wherein an oscillation sensor is arranged
on a blade support or on the device framework.

7. A cutting device according to claim 1, wherein an upper blade, which is
arranged on a vertically movable first blade support, is provided as a first blade
element and a lower blade, which is arranged on a framework support which is
provided on the device framework, is positionally fixed and serves as a second
blade support, is provided as a second blade element, an oscillation sensor
being arranged on the first blade support or a blade-support guide provided on
the device framework or being arranged on the framework support.

8. A cutting device according to claim 7, wherein at least one first oscillation
sensor is provided on the first blade support or the blade-support guide and at
least one second oscillation sensor is provided on the framework support.

9. A cutting device according to claim 8, wherein multiple first oscillation sensors
(10) are provided on the first blade support or the blade-support guide and/or
multiple second oscillation sensors are provided on the framework support.

10. A cutting device according to claim 1, wherein a rotary blade, which is arranged
on a horizontally movable first blade support, is provided as a first blade element
and a positionally fixed blade bar, which is arranged on a framework support
which is provided on the device framework, is positionally fixed and serves as a
second blade support, and along which blade bar the rotary blade is movable,
is provided as a second blade element, an oscillation sensor being arranged on
the first blade support or a guide of the first blade support that is provided on
the device framework or being arranged on the framework support or on the
device framework.

11. A cutting device according to claim 1, wherein a first rotary blade is provided as
a first blade element and a second rotary blade is provided as a second blade
element, the first rotary blade being arranged on a first blade support that is
movable on the device framework and the second rotary blade being arranged
on a second blade support that is arranged positionally fixed on the device
framework, an oscillation sensor being arranged on the first blade support or a
guide of the first blade support provided on the device framework or being
arranged on the second blade support or on the device framework.

12. A method for determining and outputting wear information concerning a first
and/or second blade element of a cutting device, the cutting device having a
device framework and also two blade elements interacting with one another for
the cutting, each blade element being arranged on a blade support, which in
turn are arranged directly or indirectly on the device framework, while oscillation
information which is a measure of an oscillation of the blade elements produced
by the interaction of the blade elements during a cut is acquired by means of at
least one oscillation sensor, and while wear information indicating the state of
one or both blade elements is determined by means of a processing device on
the basis of the oscillation information and is output by way of a display device.

13. The method according to claim 12, wherein the processing device is designed
for determining the wear information on the basis of a comparison of the
oscillation information or comparative information determined on the basis
thereof with at least one item of reference information.

14. The method according to claim 13, wherein an interpolation value, which serves
as comparative information, is determined by means of the processing device
on the basis of multiple items of oscillation information recorded one after the
other in time.

15. The method according to claim 13, wherein there is at least a first and a second
item of reference information, while a first item of wear information is output in
dependence on a comparison of the comparative value with the first item of
reference information and a second item of wear information is output a
comparison of the comparative value with the second item of reference
information.

16. The method according to claim 12, wherein multiple oscillation sensors,
arranged at various positions, are provided, the processing device being
designed for determining the wear information on the basis of the oscillation
information of the multiple oscillation sensors.

17. The method according to claim 12, wherein squaring shears comprising a
vertically movable upper blade as a first blade element and a positionally fixed
lower blade as a second blade element, or rotary shears comprising a
horizontally movable rotary blade and a positionally fixed blade bar, along which
the rotary blade moves, or a slitter comprising a movable first rotary blade and
a positionally fixed second rotary blade is/are used as the cutting device.
